(19) United States
(12) Patent Application Publication
(10) Pub. No.: US 2026/0056354 A1
(43) Pub. Date: Feb. 26, 2026

(54) OPTICAL FILTERS AND ASSOCIATED PROTECTORS

(71) Applicant: Mustard Seed Design Co., Ltd., Taipei City (TW)

(72) Inventor: Chan-Jung HSU, Taipei City (TW)

(73) Assignee: Mustard Seed Design Co., Ltd., Taipei City (TW)

(21) Appl. No.: 19/222,339

(22) Filed: May 29, 2025

(30) Foreign Application Priority Data
Jul. 23, 2024 (TW) 113127897

(51) Int. Cl. G02B 5/22

(52) U.S. Cl. CPC G02B 5/223

(57) ABSTRACT

An optical filter and associated protector are provided for reducing blue light toxicity without affecting display quality. The optical filter includes a light-absorbing layer formed on a transparent substrate. The light-absorbing layer comprises multiple dyes including a first light-absorbing dye that absorbs at least 50% blue light in a wavelength range from 435 nm to 440 nm, and a second light-absorbing dye that absorbs at least 40% orange-red light in a wavelength range from 580 nm to 630 nm with a center wavelength between 590 nm and 610 nm. A third light-absorbing dye may optionally be included to absorb at least 10% green light in a wavelength range from 500 nm to 580 nm. This configuration enables effective blue light hazard reduction while directly compensating color temperature without the need for complex color adjustment experiments, maintaining display quality with minimal color distortion.

### CROSS-REFERENCE TO RELATED APPLICATIONS

This application claims priority to Taiwan Patent Application No. 113127897, filed Jul. 23, 2024, the entire disclosure of which is hereby incorporated by reference herein.

### FIELD OF THE DISCLOSURE

The present disclosure relates to optical filtering technology, and more particularly to optical filters and protectors that reduce blue light toxicity without affecting display quality.

### BACKGROUND

Recent research studies have indicated that exposure to blue light in the wavelength range of 400 nanometers (nm) to 500 nm poses a risk of photochemical damage to the human eye. Different wavelengths of blue light have varying degrees of impact on human eyes. In response to this, the International Commission on Non-Ionizing Radiation Protection (ICNIRP) has published the “Blue Light Hazard (BLH) Function.”

In 2018, TUV Rheinland introduced the Blue Light Reduction standard (shown in Table 1) corresponding to the BLH function. This standard encompasses requirements for Blue Light Toxicity Reduction rate, Shift of Correlated Color Temperature (CCT), and transmittance. The Blue Light Toxicity Reduction rate incorporates BLH into the calculation of the blocking rate integral, yielding a value that represents the actual harm of blue light to the eyes. Simultaneously, the standard restricts the range of color temperature shift to prevent anti-blue light products from appearing excessively yellow and distorting colors.

The transmittance limitation is set to avoid products becoming too dark. This standard comprises three levels: 15%, 20%, and 30% blue light blocking. After years of development and promotion, TÜV Rheinland's blue light blocking classification standard has become a benchmark for consumers to select screen protectors that suit their needs, significantly improving the inconsistent quality issues of anti-blue light protective films in the market.

TABLE 1

| | Blue Light | Color | |
|---|---|---|---|
| | Toxicity | temperature | |
| Standard | Reduction rate | difference | Transmittance |
| 15% blue light blocking | ≥15% | ≤250 K | ≥80% |
| 20% blue light blocking | ≥20% | ≤350 K | ≥80% |
| 30% blue light blocking | ≥30% | ≤500 K | ≥80% |

In 2023, TÜV Rheinland updated its relevant standards (shown in Table 2), expanding the original three-level standard to seven levels, and adding a new requirement for the blocking rate of 435 nm-440 nm wavelengths. The highest level in the new standard is 80% blue light blocking, which means it needs to block at least 80% of any blue light wavelength between 435-440 nm, while maintaining a 40% blue light toxicity blocking rate, a color temperature shift of less than or equal to 500K, and preserving over 70% of brightness.

TABLE 2

| | 435-440 | Blue Light | Color | |
|---|---|---|---|---|
| | nm | Toxicity | temper- | |
| | Blocking | Reduction | ature | Trans- |
| Standard | rate | rate | difference | mittance |
| 20% blue light blocking | ≥20% | ≥15% | ≤250 K | ≥80% |
| 30% blue light blocking | ≥30% | ≥15% | ≤250 K | ≥80% |
| 40% blue light blocking | ≥40% | ≥20% | ≤350 K | ≥80% |
| 50% blue light blocking | ≥50% | ≥20% | ≤350 K | ≥80% |
| 60% blue light blocking | ≥60% | ≥30% | ≤500 K | ≥80% |
| 70% blue light blocking | ≥70% | ≥30% | ≤500 K | ≥80% |
| 70% blue light blocking | ≥80% | ≥40% | ≤500 K | ≥70% |

FIG. 1 shows a schematic diagram of the light transmission spectrum of a conventional anti-blue light protective film. Absorption-type anti-blue light protective films in the market mainly use blue light absorbing particles to absorb harmful blue light (as shown in the blue light absorption area 10 in FIG. 1). However, since absorbing blue light causes a decrease in color temperature, making the display appear yellowish, it is necessary to compensate in non-blue light regions using dyes (such as the red light compensation area 12 or green light compensation area 14 in FIG. 1). However, the addition of compensation areas inevitably affects brightness, reducing the overall display quality. Moreover, adjusting the three primary colors to compensate for color gamut coverage requires extensive adjustment tests and experiments, which presents certain difficulties in implementation.

Therefore, enhancing blue light hazard blocking effects while maintaining screen display quality has become a development goal for relevant manufacturers.

### SUMMARY

According to an aspect of the present disclosure, an optical filter is provided for high blue light hazard blocking while maintaining screen display quality.

In one embodiment, the optical filter has a light-absorbing layer formed on a transparent substrate. The light-absorbing layer is composed of multiple mixed dyes and comprises a first light-absorbing dye and a second light-absorbing dye. The first light-absorbing dye absorbs at least 50% of blue light in a wavelength range from 435 nm to 440 nm. The second light-absorbing dye absorbs at least 40% of orange-red light in a wavelength range from 580 nm to 630 nm in which a center wavelength is between 590 nm and 610 nm.

In another embodiment, the first light-absorbing dye absorbs at least 80% of any blue light wavelength between 435-440 nm. The second light-absorbing dye absorbs at least 60% orange-red light in a wavelength range from 580 nm to 630 nm in which a center wavelength is between 590 nm and 610 nm.

According to another aspect of the present disclosure, an optical protector is provided for high blue light hazard blocking while maintaining screen display quality.

In one embodiment, the optical protector comprises a transparent substrate. The transparent substrate has an optical filter that is composed of a light-absorbing layer mixed with multiple dyes. The light-absorbing layer comprises a first light-absorbing dye, a second light-absorbing dye, and a third light-absorbing dye. The first light-absorbing dye absorbs at least 50% blue light in a wavelength range from 435 nm to 440 nm. The second light-absorbing dye absorbs at least 40% orange-red light in a wavelength range from 580 nm to 630 nm in which a center wavelength is between 590 nm and 610 nm. The third light-absorbing dye absorbs at least 10% green light in a wavelength range from 500 nm to 580 nm.

Unlike conventional methods that filter blue light by adjusting the three primary colors to compensate for color gamut coverage (requiring extensive adjustment tests and experiments), the present disclosure directly compensates color temperature by absorbing orange-red light in the wavelength range of 580 nm to 630 nm, with a center wavelength between 590 nm and 610 nm. Furthermore, a small amount of absorbing material can be added for green light in a wavelength range from 500 nm to 580 nm to achieve a white balance effect approaching true colors, completely eliminating the need for complex color adjustment experiments.

### BRIEF DESCRIPTION OF THE DRAWINGS

FIG. 1 is a schematic diagram of the light transmission spectrum of a conventional anti-blue light protective film;

FIG. 2 is an exemplary diagram illustrating a spectrum in accordance with an embodiment of the present disclosure;

FIG. 3 is an exemplary diagram illustrating a spectrum in accordance with another embodiment of the present disclosure;

FIG. 4 is an exemplary diagram illustrating a spectrum in accordance with other embodiments of the present disclosure;

FIG. 5 is an exemplary diagram illustrating a comparison of spectra depicted in FIGS. 1 and 2;

FIG. 6 is an exemplary diagram illustrating an optical protector in accordance with an embodiment of the present disclosure;

FIG. 7 is an exemplary diagram illustrating an optical protector in accordance with another embodiment of the present disclosure; and

FIG. 8 is an exemplary diagram illustrating an optical protector in accordance with other embodiments of the present disclosure.

### DETAILED DESCRIPTIONS

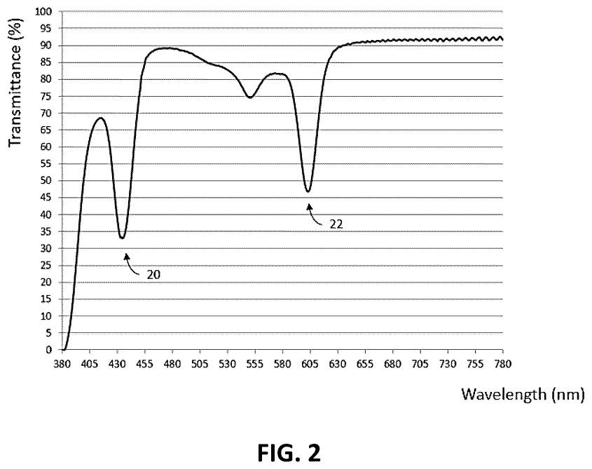

With reference to FIG. 2, an exemplary spectrum in accordance with an embodiment of the present disclosure is illustrated. In this embodiment, the optical filter is composed of a light-absorbing layer formed by mixing multiple dyes onto a transparent substrate. The light-absorbing layer comprises a first light-absorbing dye, a second light-absorbing dye, and a third optional light-absorbing dye.

For ease of explanation, the spectral diagrams in the figures are drawn using light transmittance. When light emitted from a light source passes through the transparent substrate, a 60% absorption rate is equivalent to a 40% transmittance. As shown in FIG. 2, the first light-absorbing dye absorbs 50% to 79% (i.e., 21% to 50% transmittance) of any blue light wavelength in the 435-440 nm wavelength range 20. The second light-absorbing dye absorbs at least 40% to 70% orange-red light in a wavelength range 22 from 580 nm to 630 nm (i.e., a valley curve depicts 30% to 60% transmittance). Adding orange-red light absorbing dye is able to increase color temperature.

In this embodiment, the color temperature difference is controlled within 500K from a light emitting source. For instance, the color temperature of light from the emitting source will be decreased from 6500K to 5000K due to the absorption of the first light-absorbing dye. The 5000K yellowish color temperature will be compensated back to 6000K to 6500K by absorbing the orange-red light with the second light-absorbing dye. Based on the inventors' experiments, the wavelength absorption rate of the first light-absorbing dye is positively correlated with the maximum wavelength absorption rate of the second light-absorbing dye. The value of the ratio of the wavelength absorption rates is between 0.7 to 2.

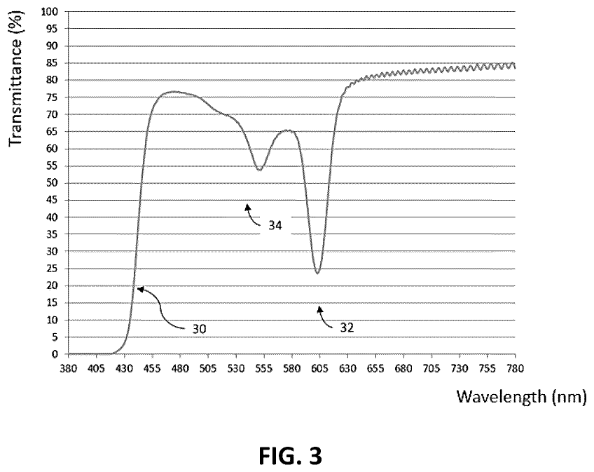

With reference to FIG. 3, an exemplary spectrum in accordance with another embodiment of the present disclosure is illustrated. In general, the wavelength range of visible light for most human eyes is between 380 nm and 780 nm. The 380 nm to 410 nm violet-blue light wavelength range has the highest energy, followed by the blue light range. The wavelength range of blue light that causes photochemical damage to human eyes is 400 nm to 500 nm. However, the visible violet-blue light in the 380 nm to 410 nm range is closest to ultraviolet and has stronger energy. The power of the visible violet-blue is strong enough to penetrate the skin deeply into the dermis layer, which damages collagen and elastic fibers, and produces unwanted free radicals in the skin, thereby accelerating skin aging and increasing the production of melanin.

Therefore, in this embodiment, as shown in FIG. 3, the first light-absorbing dye not only absorbs 50% to 79% blue light in a wavelength range 20 from 435 nm to 440 nm, but also absorbs 80% to 100% (i.e., 0% to 20% transmittance) violet-blue light in a wavelength range 24 from 380 nm to 410 nm. Comparing the valley waveform of 380 nm to 440 nm transmittance depicted in FIG. 2, the waveform in FIG. 3 is in the form of a slope.

However, in order to achieve better display, it should be noted that a smaller difference in color temperature does not necessarily mean a smaller color discrepancy as perceived by the human eye. Although the second light-absorbing dye compensates for color temperature, the wavelength range to which the human eye responds varies. Even with the same color temperature, there can still be different color perceptions, which is known as color tolerance.

Through experiments conducted by the inventors, it was discovered that after the second light-absorbing dye in this disclosure absorbs orange-red light, even after compensation, there is still a perceptible color difference in the visual appearance of white color at 6000K-6500K color temperature compared to the original spectrum. Therefore, the light-absorbing layer in this disclosure can add another third light-absorbing dye for the green light wavelength range 26 of 500 nm to 580 nm. The maximum absorption peak is between 10% and 40% (i.e., the lowest point of the valley in the transmittance waveform of FIG. 2 is between 60% and 90%). The maximum absorption rate of the second light-absorbing dye in the 580 nm-630 nm range is positively correlated with the maximum absorption rate of the third light-absorbing dye in the 500 nm-580 nm range, and has a ratio ranging between 1 and 7.

As shown in FIG. 3, the preferable experiment results for the current embodiment demonstrate that, while maintaining an overall light transmittance above 80%, the first light-absorbing dye absorbs about 65% (i.e., 35% transmittance) blue light in a wavelength 20 near 435 nm. The second light-absorbing dye absorbs about 55% (i.e., 45% transmittance) orange-red light with a peak absorption in a wavelength range 22 near 600 nm. The ratio of the absorption rate of the first light-absorbing dye to that of the second light-absorbing dye is 1.18. The third light-absorbing dye absorbs about 25% (i.e., 75% transmittance) green light in a wavelength 26 with a peak absorption near 550 nm. The absorption rates of the second and third light-absorbing dyes are positively correlated, with a ratio of 2.2. In this manner, the embodiment effectively reduces blue light hazards, maintains high optical clarity (overall transmittance greater than 80%), and preserves a white balance effect closest to true colors.

The absorption bands corresponding to the aforementioned light-absorbing dyes refer to the wavelengths within the desired range where the material exhibits optimal absorption effects. However, there are still overlapping effects in other parts of the spectrum, and the mentioned absorption rates may be the result of a single material or a combination of two or more materials. For example, the first light-absorbing dye for absorption in the 380 nm to 410 nm range may be composed of two or more light-absorbing particle materials.

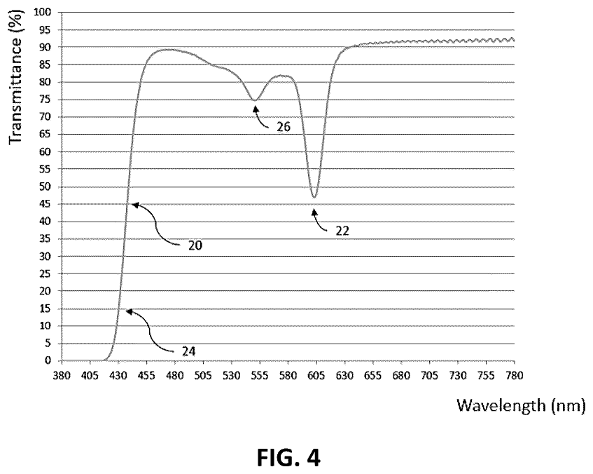

With further reference to FIG. 4, an exemplary spectrum in accordance with other embodiments of the present disclosure is illustrated. In this embodiment, while maintaining an overall above 70% light transmittance and controlling the color temperature difference within 500K, the first light-absorbing dye absorbs 80% to 100% (i.e., 0% to 20% transmittance) of any blue light wavelength in the 435 nm to 440 nm wavelength range 30. The second light-absorbing dye absorbs 60% to 90% (i.e., 10% to 40% transmittance) orange-red light in a wavelength range 32 from 580 nm to 630 nm. The ratio of the wavelength absorption rate of the first light-absorbing dye to the wavelength absorption rate of the second light-absorbing dye is between 0.88 and 1.67. Similar to the embodiment mentioned above, the third light-absorbing dye absorbs 25% to 55% (i.e., 45% to 75% transmittance) green light in a wavelength range 34 from 500 nm to 580 nm. The ratio of the wavelength absorption rate of the second light-absorbing dye to the wavelength absorption rate of the third light-absorbing dye is between 1.09 and 3.6.

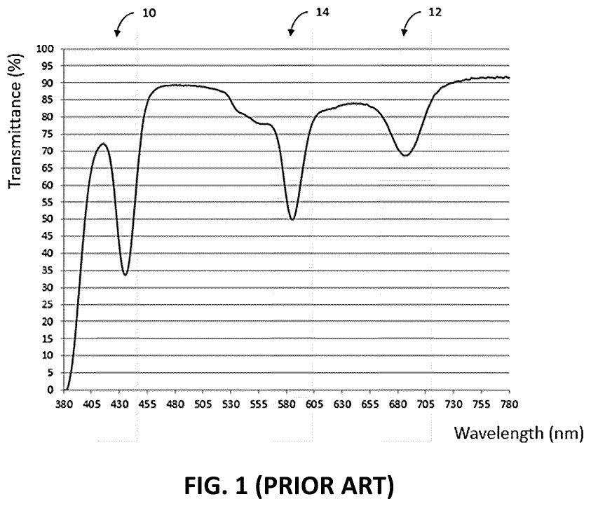

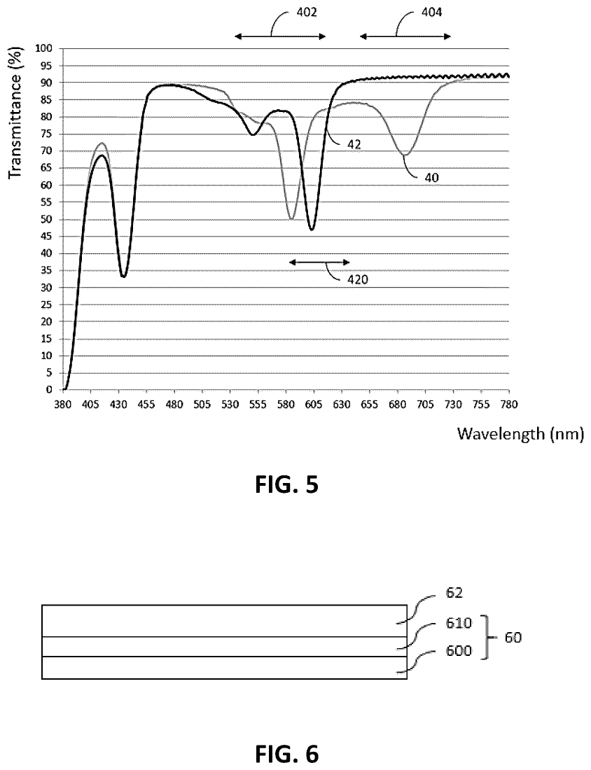

With reference to FIG. 5, a comparison of spectra depicted in FIGS. 1 and 2 is illustrated. For facilitating comparison and explanation, it is noted that anti-blue light products in the market, especially those using dye absorption technology for blue light, mostly focus on color temperature compensation after filtering blue light. Within the desired color temperature range and acceptable transmittance, they adjust the spectra of the three primary colors (Red, Green, and Blue, RGB) to ensure that the color gamut after filtering is as close as possible to the color gamut before filtering (color gamut coverage). Such an approach presents certain difficulties in implementation. Besides finding suitable dyes, it requires extensive testing and experimentation for proper formulation. As shown in spectrum waveform 40 of FIG. 5, the green light wavelength range 402 (near 580 nm) has significant transmittance decrease and a much wider full width at half maximum range in red light wavelength range 404 (near 680 nm). The conventional means uses different ratios of green and red to compensate blue (color adjust) for the filtered blue light.

As shown in spectrum waveform 42 of FIG. 5, the present disclosure has a relatively simple logic in implementation. Within an acceptable color temperature difference range (e.g., less than 500K), if the absorption rate of the first light-absorbing dye at any wavelength in the 435 nm to 440 nm band is greater than 40%, and the second light-absorbing dye with an absorption rate ratio of about 1.2 corresponding to the first light-absorbing dye has a maximum absorption of about 55% (i.e., 45% transmittance) orange-red light in a wavelength range 420 from 580 nm to 630 nm, the color temperature can be directly compensated. The present disclosure completely eliminates the need for complex color adjustment experiments. Moreover, without significantly changing the color temperature, a small amount of green light absorbing dyes for 520 nm to 585 nm wavelength absorption can be added to achieve a white balance effect that is closest to true colors.

Regarding the certification by TUV Rheinland mentioned in the background section, the present disclosure can easily fulfill the latest and most stringent 80 standard. The data are shown in the table below.

TABLE 3

| Wavelength (nm) | 380-410 | 435-440 | 550-580 | 580-630 | 630-780 |
|---|---|---|---|---|---|
| Average | 5% | 35% | 75% | 65% | 90% |
| transmittance (%) | | | | | |

With reference to FIG. 6, an optical protector in accordance with an embodiment of the present disclosure is illustrated. The optical protector can be applied as a protective film for screen display applications. The range of screen display application products includes, but is not limited to, computers, tablets, televisions, or smartphones. In this embodiment, as shown in FIG. 6, the optical protector applied to a screen product includes an optical filter 60 and a transparent cover plate 62. The optical filter 60 is composed of a light-absorbing layer 610 mixed with multiple dyes, which is coated or sprayed on a transparent substrate 600. The transparent cover plate 62 is attached to the light-absorbing layer 610 with optical adhesive.

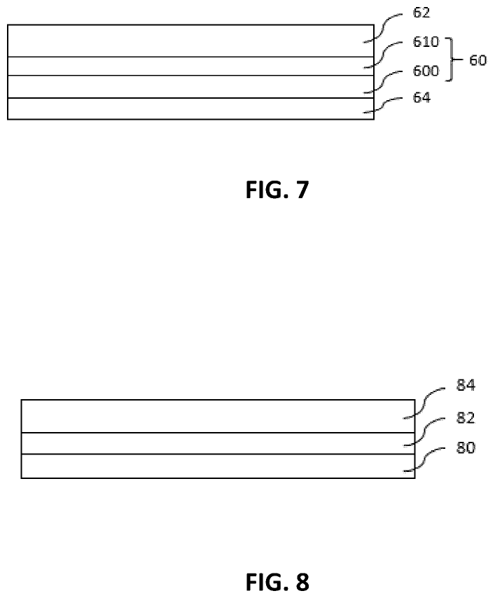

With reference to FIG. 7, an optical protector in accordance with another embodiment of the present disclosure is illustrated. In this embodiment, the optical protector may further comprise an optional silicone adhesive layer 64 on the transparent substrate 600 corresponding to another side of the light-absorbing layer 610. The silicone adhesive layer 64 is configured for the optical protector to be attached onto the screen. In some embodiments, the optical filter 60 is composed of multiple interlaced transparent substrates 600 and light-absorbing layers 610.

In some embodiments, the transparent substrate 600 or the transparent cover 62 may be made of a substrate material selected from any material from a group consisting of glass, polymethylmethacrylate (PMMA), polyethylene terephthalate (PET), and polyurethane (PU).

With reference to FIG. 8, an optical protector in accordance with other embodiments of the present disclosure is illustrated. As aforementioned, increasing the absorption rate of the first light-absorbing dye will result in a decrease in transmittance. Some electronic applications may consider this a drawback because it may require more power to compensate for the reduced brightness. However, for applications that require high blue light filtering, especially products prioritizing eye health such as eyeglass lenses or sunglasses where low light transmittance is acceptable, this approach can be particularly beneficial.

Accordingly, as shown in FIG. 8, in this embodiment, the transparent substrate 80 of the optical protector may be a glasses lens. The light-absorbing layer 82 of the optical filter may be coated or sprayed on a side of the transparent substrate 80. A protective film 84 may be coated on the light-absorbing layer 82 corresponding to another side of the transparent substrate 80. Moreover, for anti-ultraviolet use such as sunglasses applications, similar to the aforementioned light-absorbing dye, the ultraviolet dye can selectively be mixed into the light-absorbing layer 82 or the protective film 84. Such glasses lenses can both filter blue light and ultraviolet at the same time.

Further, for finished lens products, the transparent substrate 80 may be made of a substrate material mixed with the dyes of the optical filter by means of compression molding or injection molding.

Accordingly, the present disclosure provides optical filters and protectors for blue light blocking. The optimal absorption rate of the first light-absorbing dye in the 430 nm to 440 nm wavelength range can be determined based on the acceptable light transmittance for practical applications. Then, within an acceptable color temperature difference range (such as 350K or 500K), the second light-absorbing dye with an absorption rate ratio of about 1.2 corresponding to the first light-absorbing dye can be used. The second light-absorbing dye absorbs orange-red light in the 590 nm to 610 nm wavelength range for color temperature compensation. Without significantly altering the color temperature, a small amount of third light-absorbing dye for absorbing green light in the 520 nm to 585 nm wavelength range can further be added. Therefore, the present disclosure achieves both high blue light absorption and a white balance effect closest to true colors.

What is claim is:

1. An optical filter having a light-absorbing layer mixed with multiple dyes, which is formed on a transparent substrate, wherein the light-absorbing layer comprises:
a first light-absorbing dye absorbing at least 50% of any blue light wavelength between 435-440 nm; and
a second light-absorbing dye absorbing at least 40% orange-red light in a wavelength range from 580 nm to 630 nm in which a center wavelength is between 590 nm and 610 nm.

2. The optical filter as claimed in claim 1, wherein a wavelength absorption rate of the first light-absorbing dye is positively correlated with a wavelength absorption rate of the second light-absorbing dye.

3. The optical filter as claimed in claim 2, wherein a ratio of the wavelength absorption rate of the first light-absorbing dye to the wavelength absorption rate of the second light-absorbing dye is between 0.7 and 2.

4. The optical filter as claimed in claim 1, wherein the first light-absorbing dye absorbs over 80% violet-blue light in a wavelength range from 380 nm to 410 nm.

5. The optical filter as claimed in claim 1, further comprising a third light-absorbing dye for absorbing at least 10% green light in a wavelength range from 500 nm to 580 nm, wherein a wavelength absorption rate of the second light-absorbing dye is positively correlated with a wavelength absorption rate of the third light-absorbing dye.

6. The optical filter as claimed in claim 5, wherein the first light-absorbing dye, the second light-absorbing dye, and the third light-absorbing dye comprise one or more light absorbing materials.

7. The optical filter as claimed in claim 5, wherein:
a ratio of a wavelength absorption rate of the first light-absorbing dye to the wavelength absorption rate of the second light-absorbing dye is between 0.7 and 2; and
a ratio of the wavelength absorption rate of the second light-absorbing dye to the wavelength absorption rate of the third light-absorbing dye is between 1 and 7.

8. An optical filter having a light-absorbing layer mixed with multiple dyes, which is formed on a transparent substrate, wherein the light-absorbing layer comprises:
a first light-absorbing dye absorbing at least 80% of any blue light wavelength between 435-440 nm; and
a second light-absorbing dye absorbing at least 60% orange-red light in a wavelength range from 580 nm to 630 nm in which a center wavelength is between 590 nm and 610 nm.

9. The optical filter as claimed in claim 8, further comprising a third light-absorbing dye for absorbing at least 10% green light in a wavelength range from 500 nm to 580 nm, wherein a wavelength absorption rate of the second light-absorbing dye is positively correlated with a wavelength absorption rate of the third light-absorbing dye.

10. The optical filter as claimed in claim 9, wherein:
a ratio of a wavelength absorption rate of the first light-absorbing dye to the wavelength absorption rate of the second light-absorbing dye is between 0.88 and 1.67; and
a ratio of the wavelength absorption rate of the second light-absorbing dye to the wavelength absorption rate of the third light-absorbing dye is between 1.09 and 3.6.

11. The optical filter as claimed in claim 8, wherein the first light-absorbing dye absorbs over 80% violet-blue light in a wavelength range from 380 nm to 410 nm.

12. An optical protector comprising a transparent substrate, the transparent substrate having an optical filter that is composed of a light-absorbing layer mixed with multiple dyes, wherein the light-absorbing layer comprises:
a first light-absorbing dye absorbing at least 50% of any blue light wavelength between 435-440 nm;
a second light-absorbing dye absorbing at least 40% orange-red light in a wavelength range from 580 nm to 630 nm in which a center wavelength is between 590 nm and 610 nm; and
a third light-absorbing dye absorbing at least 10% green light in a wavelength range from 500 nm to 580 nm.

13. The optical protector as claimed in claim 12, wherein the transparent substrate is made of a substrate material and dyes of the optical filter by means of compression molding or injection molding.

14. The optical protector as claimed in claim 12, wherein the optical filter is coated or sprayed on a side of the transparent substrate.

15. The optical protector as claimed in claim 14, further comprising a transparent cover plate being attached to the light-absorbing layer corresponding to another side of the transparent substrate.

16. The optical protector as claimed in claim 15, further comprising a silicone adhesive layer on the transparent cover plate corresponding to another side of the light-absorbing layer.

17. The optical protector as claimed in claim 14, further comprising a protective film coated on the side of the optical filter corresponding to another side of the transparent substrate.

18. The optical protector as claimed in claim 17, further comprising an ultraviolet dye being selectively mixed into the optical filter or the protective film.
